(19) United States
(12) Patent Application Publication
(10) Pub. No.: US 2022/0245003 A1
(43) Pub. Date: Aug. 4, 2022

(54) DEVICE FOR MANAGING VIRTUALIZED RESOURCES

(71) Applicant: TEN INC., Daegu (KR)

(72) Inventor: Se Jin OH, Seoul (KR)

(73) Assignee: TEN INC., Daegu (KR)

(21) Appl. No.: 17/725,482

(22) Filed: Apr. 20, 2022

Related U.S. Application Data
(63) Continuation of application No. PCT/KR2021/020174, filed on Dec. 29, 2021.

(30) Foreign Application Priority Data
Jan. 18, 2021 (KR) 10-2021-0007033

(51) Int. Cl. G06F 9/50

(52) U.S. Cl. CPC G06F 9/5077; G06F 9/5038; G06F 9/5044

(57) ABSTRACT

According to an embodiment of the present disclosure, a resource management device for managing virtualized resources may be configured to: define at least one resource block including an allocated size of at least one type of resource; determine a resource block type and a resource block quantity required for a service; determine, based on the resource block type and the resource block quantity, a first server for executing the service from a server pool including a plurality of servers; and execute a first process on the first server according to the service.

### CROSS-REFERENCE OF RELATED APPLICATIONS AND PRIORITY

The present application is a continuation of International Patent Application No. PCT/KR2021/020174, filed on Dec. 29, 2021, which claims priority to Korean Patent Application No. 10-2021-0007033, filed on Jan. 18, 2021, the disclosure of which are incorporated by reference as if they are fully set forth herein.

### TECHNICAL FIELD

The present disclosure relates to a method, device, and computer program for managing virtualized resources.

### BACKGROUND ART

Along with the development of information and communication technology, artificial intelligence techniques have been introduced into many applications. For example, conventional text-to-speech technology generates voice based on rules, but recent text-to-speech technology generates voice using a trained artificial neural network.

Many computational resources are required to train an artificial neural network or provide a service using an artificial neural network, and graphic processing units (GPUs) are generally used as computational resources.

In the related art, GPUs are used on the basis of hardware units to execute or provide services. For example, in the related art, processes for providing a service are performed using a whole GPU.

However, in many cases, using GPUs on the basis of hardware units (or whole GPUs) is not efficient in that individual services do not require large amounts of computation and the sizes of required resources vary over time.

### DESCRIPTION OF EMBODIMENTS

### Technical Problem

The present disclosure is provided to solve the above-described problems by efficiently using resources.

In addition, the present disclosure provides a method of measuring the quantity of resources required for a service when a user introduces the service, and a method of recommending suitable hardware according to measured results.

### Solution to Problem

According to an embodiment of the present disclosure, a resource management device for managing virtualized resources may be configured to: define at least one resource block including an allocated size of at least one type of resource; determine a resource block type and a resource block quantity required for a service; determine, based on the resource block type and the resource block quantity, a first server for executing the service from a server pool including a plurality of servers; and execute a first process on the first server according to the service.

When defining the at least one resource block, the resource management device may be configured to: determine a size of a first type of resource, a size of a second type of resource, a size of a third type of resource, and a size of a fourth type of resource, which are allocated to a first resource block; and determine a size of the first type of resource, a size of the second type of resource, a size of the third type of resource, and a size of the fourth type of resource, which are allocated to a second resource block.

When determining the resource block quantity, the resource management device may be configured to: calculate an expected response time for a quantity of each of at least one type of resource block, the response time being a time required for the first process to generate a response to a request when the first process is executed using a predetermined quantity of a predetermined type of resource block; and determine, with reference to the response time, a resource block type and a resource block quantity, which are required for the first process.

When determining the first server, the resource management device may be configured to: check a requested resource size according to the determined resource block type and quantity; search the server pool for at least one server having an idle resource greater than the requested resource size; and determine, according to a predetermined condition, one of the at least one server as the first server.

When executing the first process, the resource management device may be configured to create a container having an allocated size of at least one type of resource according to the determined resource block type and resource block quantity; and execute the first process in the container.

When a response time of the first process executed on the first server satisfies a predetermined condition, the resource management device may be configured to: determine, with reference to the resource block type and the resource block quantity required for the service, a second server from the server pool to additionally execute the service on the second server; and execute a second process on the second server according to the service.

The resource management device may be configured to determine, based on a first delay time required for the first process to generate a response to a request and a second delay time required for the second process to generate a response to the request, one of the first process and the second process as a process for processing a new request.

When the resource management device determines that the first process executed on the first server is in a predetermined state, the resource management device may be configured to select a third server from the server pool with reference to the resource block type and the resource block quantity required for the service to additionally execute the service on the third server; and execute a third process on the third server according to the service.

The resource management device may be configured to select a fourth server from the server pool with reference to the resource block type and the resource block quantity required for the service to additionally execute the service on the fourth server when the service is updated; execute a fourth process on the fourth server according to the updated service; and stop the first process, which is being executed on the first server.

According to an embodiment of the present disclosure, a resource management method for managing virtualized resources may include: defining at least one resource block including an allocated size of at least one type of resource; determining a resource block type and a resource block quantity required for a service; determining, based on the resource block type and the resource block quantity, a first server for executing the service from a server pool including a plurality of servers; and executing a first process on the first server according to the service.

The defining of the at least one resource block may include: determining a size of a first type of resource, a size of a second type of resource, a size of a third type of resource, and a size of a fourth type of resource, which are allocated to a first resource block; and determining a size of the first type of resource, a size of the second type of resource, a size of the third type of resource, and a size of the fourth type of resource, which are allocated to a second resource block.

The determining of the resource block quantity may calculate an expected response time for a quantity of each of at least one type of resource block, the response time being a time required for the first process to generate a response to a request when the first process is executed using a predetermined quantity of a predetermined type of resource block; and determining, with reference to the response time, a resource block type and a resource block quantity, which are required for the first process.

The determining of the first server may include: checking a requested resource size according to the determined resource block type and quantity; searching the server pool for at least one server having an idle resource greater than the requested resource size; and determining, according to a predetermined condition, one of the at least one server as the first server.

The executing of the first process may include: creating a container having an allocated size of at least one type of resource according to the determined resource block type and resource block quantity; and executing the first process in the container.

The resource management method may further include: determining whether a response time of the process executed on the first server satisfies a predetermined condition; whether the response time of the process executed on the first server satisfies the predetermined condition, determining, with reference to the resource block type and the resource block quantity required for the service, a second server from the server pool to additionally execute the service on the second server; and executing a second process on the second server according to the service.

The resource management method may further include determining, based on a first delay time required for the first process to generate a response to a request and a second delay time required for the second process to generate a response to the request, one of the first process and the second process as a process for processing a new request.

The resource management method may further include: determining whether the first process executed on the first server is in a predetermined state; when the first process executed on the first server is in a predetermined state, selecting a third server from the server pool with reference to the resource block type and the resource block quantity required for the service to additionally execute the service on the third server; and executing a third process on the third server according to the service.

The resource management method may further include: selecting a fourth server from the server pool with reference to the resource block type and the resource block quantity required for the service to additionally execute the service on the fourth server when the service is updated; executing a fourth process on the fourth server according to the updated service; and stopping the first process, which is being executed on the first server.

According to an embodiment of the present disclosure, a device for recommending a resource size for operating a service may be configured to obtain an expected performance value of the service; calculate performance values by executing a process for the service while changing at least one of a type of resource block and a resource block quantity under a first traffic condition, the resource block being a virtualized resource including an allocated size of at least one type of resource; and determining a combination of resource block types and resource block quantities, which satisfies the expected performance value.

The device may be configured to: calculate performance values from the execution of the service by executing the service under a second traffic condition while changing the number of processes, which are executed using a resource block type and a resource block quantity, according to the combination; and determine a number of processes, which satisfies the expected performance value.

The device may be configured to determine the total size of resources required to operate the service, based on the resource block type, the resource block quantity, and the number of processes.

The device may be configured to determine at least one piece of hardware suitable for operating the service, based on the total size of resources.

The device may be configured to compare the expected performance value with performance values obtained when a plurality of resource blocks of each of a plurality of types are used to execute the process.

According to an embodiment of the present disclosure, a resource size recommending method of recommending a resource size for operating a service may include: obtaining an expected performance value of the service; calculating performance values by executing a process for the service while changing at least one of a type of resource block and a resource block quantity under a first traffic condition, the resource block being a virtualized resource including an allocated size of at least one type of resource; and determining a combination of resource block types and resource block quantities, which satisfies the expected performance value.

After the determining of the combination, the resource size recommending method may further include: calculating performance values from the execution of the service by executing the service under a second traffic condition while changing the number of processes, which are executed using a resource block type and a resource block quantity, according to the combination; and determining a number of processes, which satisfies the expected performance value.

After the determining of the number of processes, the resource size recommending method may further include determining the total size of resources required to operate the service, based on the resource block type, the resource block quantity, and the number of processes.

After the determining of the total size of resources, the resource size recommending method may further include determining at least one piece of hardware suitable for operating the service, based on the total size of resources.

The calculating of the performance values may include comparing the expected performance value with performance values obtained when a plurality of resource blocks of each of a plurality of types are used to execute the process.

### Advantageous Effects of Disclosure

According to the present disclosure, resources may be more efficiently used. In particular, resources are allocated on the basis of block units according to the scale of a service such that the service may be stably executed while guaranteeing stable execution of other services sharing hardware with the service.

In addition, according to the present disclosure, when introducing a new service, it is possible to accurately measure the quantity of resources required for the new service.

In addition, the quantity of required resources may also be accurately measured according to the state of each service.

Furthermore, according to the present disclosure, hardware capable of providing measured resources may be recommended.

### BRIEF DESCRIPTION OF DRAWINGS

FIG. 1 is a view schematically illustrating a configuration of a system for managing virtualized resources according to an embodiment of the present disclosure.

FIG. 2 is a view schematically illustrating a configuration of a resource server 300A according to an embodiment of the present disclosure.

FIG. 3 is a view schematically illustrating a configuration of a server 100 according to an embodiment of the present disclosure.

FIGS. 4 and 5 are views illustrating example configurations of an artificial neural network.

FIG. 6 is a view illustrating example resource blocks.

FIG. 7 shows an example of calculating expected response times according to the quantity of resource blocks for each of one or more types of resource blocks.

FIG. 8 shows an example of calculating expected response times according to the number of processes.

FIG. 9 is a view illustrating a requested resource 610 and example resource statuses 620A, 630A, and 640A of resource servers.

FIG. 10 is a view illustrating resource statuses 620B, 630B, and 640B in an example situation in which a third server is determined server I.

FIG. 11 is a view illustrating resource statuses 620C, 630C, and 640C in an example situation in which a first server is determined as server II in the situation shown in FIG. 10.

FIG. 12 is a view illustrating resource statuses 620D, 630D, and 640D in an example situation in which the first server is determined as server III in the situation shown in FIG. 10.

FIGS. 13 and 14 are views illustrating resource statuses 620E, 630E, and 640E over time when a process is updated in the situation shown in FIG. 10.

FIG. 15 is a flowchart illustrating a resource management method according to an embodiment of the present disclosure.

FIG. 16 is a flowchart illustrating a resource management method according to an embodiment of the present disclosure.

FIG. 17 is a flowchart illustrating a resource management method according to an embodiment of the present disclosure.

FIG. 18 is a flowchart illustrating a resource management method according to an embodiment of the present disclosure.

FIG. 19 is a flowchart illustrating a method of recommending a resource size, according to an embodiment of the present disclosure.

### BEST MODE

According to an embodiment of the present disclosure, a resource management device for managing virtualized resources may be configured to: define at least one resource block including an allocated size of at least one type of resource; determine a resource block type and a resource block quantity required for a service; determine, based on the resource block type and the resource block quantity, a first server for executing the service from a server pool including a plurality of servers; and execute a first process on the first server according to the service.

### Mode of Disclosure

The present disclosure may have various different forms and various embodiments, and specific embodiments are illustrated in the accompanying drawings and are described herein in detail. Effects and features of the present disclosure, and methods of achieving the effects and features will become apparent with reference to the accompanying drawings and the embodiments described below in detail. However, the present disclosure is not limited to the embodiments described below and may be implemented in various forms.

Hereinafter, the embodiments will be described with reference to the accompanying drawings. In the drawings, like reference numerals denote like elements, and overlapping descriptions thereof will be omitted.

In the following descriptions of the embodiments, terms such as “first” and “second” are not used for purposes of limitation, but are only used to distinguish one element from another element. In the following descriptions of the embodiments, the terms of a singular form may include plural forms unless referred to the contrary. In the following descriptions of the embodiments, the meaning of terms such as “include” and “comprise” specifies a property or an element, but does not exclude other properties or elements. In the drawings, the sizes of elements may be exaggerated for clarity. For example, in the drawings, the size or shape of each element may be arbitrarily shown for illustrative purposes, and thus the present disclosure should not be construed as being limited thereto.

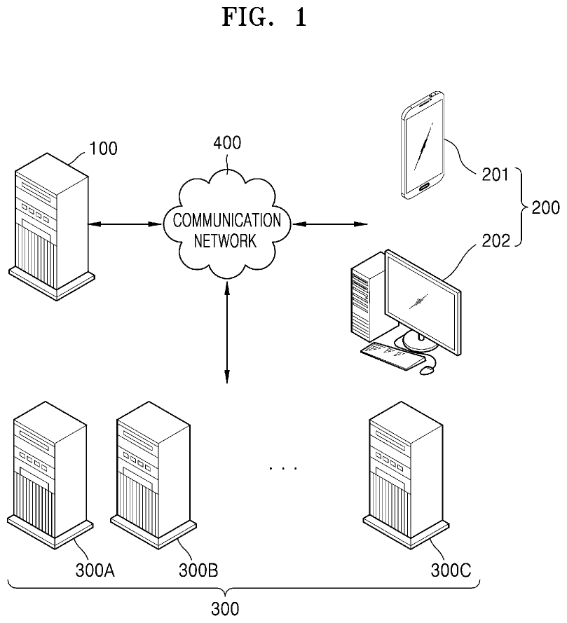

FIG. 1 is a view schematically illustrating a configuration of a system for managing virtualized resources according to an embodiment of the present disclosure.

Referring to FIG. 1, the system for managing virtualized resources, according to the embodiment of the present disclosure, may include a server 100, a user terminal 200, resource servers 300, and a communication network 400.

The system for managing virtualized resources, according to the embodiment of the present disclosure, may manage resources of the resource servers 300 on the basis of resource blocks each including an allocated size of at least one type of resource. For example, the system according to the embodiment of the present disclosure may determine a resource block type and quantity required for a new service, and may use the determined type and quantity to execute a process for the new service on the resource servers 300.

In the present disclosure, the term “resource” (or an individual type of resource) may refer to a resource (or computing resource) which a computing device may use for a given purpose. For example, in a computing device, such as the resource servers 300, a resource may refer to a concept encompassing the quantity of available CPU cores, the capacity of available memories, the quantity of available GPU cores, the capacity of available GPU memories, and an available network bandwidth. However, this is merely an example, and the spirit of the present disclosure is not limited thereto. Any computing (or computing-related) resources that may be used for a given purpose may be referred to as resources in the present disclosure.

In the present disclosure, the term “resource block” may refer to a virtualized resource (or integrated resource) including an allocated size of at least one type of resource. For example, a first resource block may refer to a virtualized resource or a combination of resources, which includes 0.5 CPU core, 2 gigabytes of memory, a 0.5 GPU core, and 512 megabytes of GPU memory.

Therefore, executing a process using the first resource block or using as many resources as the first resource block may mean using resources corresponding to the first resource block for the execution of the process. For example, executing a process using the first resource block may mean executing the process using 0.5 CPU core, 2 gigabytes of memory, 0.5 GPU core, and 512 megabytes of GPU memory (or may mean allocating as many resources as described above for the execution of the process).

In addition, executing a process using two first resource blocks may mean executing the process using one CPU core, 4 gigabytes of memory, one GPU core, and 1024 megabytes of GPU memory (or may mean allocating as many resources as described above for the execution of the process). However, the aforementioned size of the first resource block is merely an example and the spirit of the present disclosure is not limited thereto.

In the present disclosure, the term “service” may refer to an application to be executed on a computing device, such as the resource servers 300, for a given purpose. For example, a service may refer to an application for a TTS service, which generates voice from text in response to a request from the user terminal 200.

In addition, a service may include one or more processes or may be composed of one or more processes. Therefore, in the present disclosure, the term “process” may refer to work (or a task) which is performed for operating (or providing) a service.

In the present disclosure, the term “service” may be used as a concept encompassing or superior to “processes.”

In the present disclosure, “executing” a process may mean generating a container corresponding to a resource block type and size determined for the process and executing the process (or a program corresponding to the process) in the container.

In this case, the term “container” may refer to a set of processes that may abstract (or isolate) applications (or individual processes) from an actual operating environment (or the rest of the system).

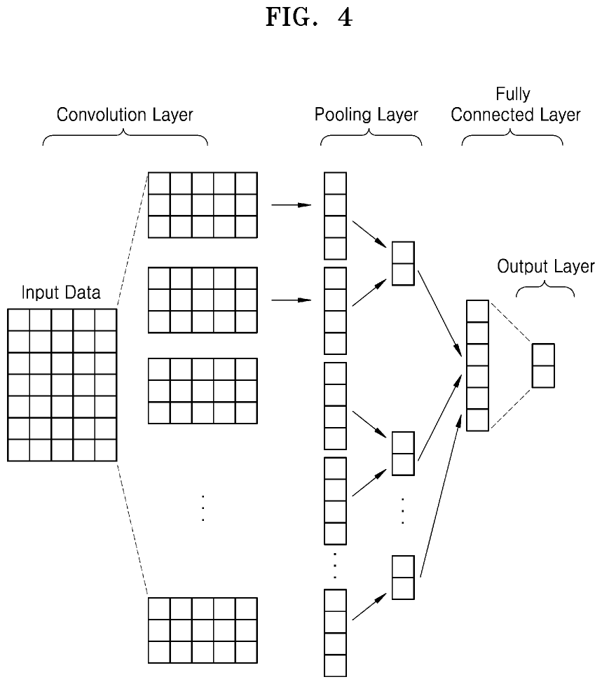

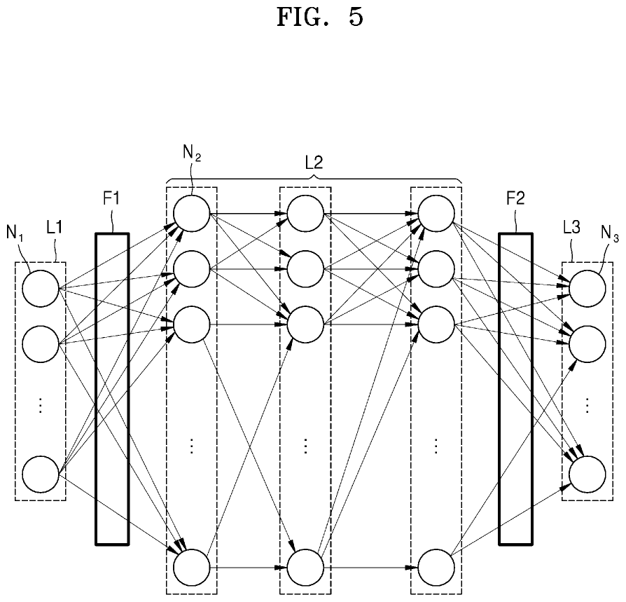

In the present disclosure, the term “artificial neural network” may refer to an artificial neural network, which is generated by the server 100 and/or the resource servers 300 for a given purpose and trained using a machine learning or deep learning method. Structures of such neural networks will be described later with reference to FIGS. 4 and 5.

The user terminal 200 according to the embodiment of the present disclosure may be any of various types of devices that mediate the user and the server 100 such that the user may use various services provided by the server 100. In other words, the user terminal 200 according to the embodiment of the present disclosure may refer to any of various devices for transmitting and receiving data to and from the server 100.

In an embodiment of the present disclosure, the user terminal 200 may transmit, to the server 100, a service to be executed and an expected performance value of the service such that appropriate resources may be allocated for the service. In addition, the user terminal 200 may receive a resource use status or the like from the server 100 such that a user may check the states of the resource servers 300. As shown in FIG. 1, the user terminal 200 may be a portable terminal 201 or a computer 202.

In addition, to perform the functions described above, the user terminal 200 may include a display unit for displaying content or the like, and an input unit for obtaining a user's input for such content. In this case, the input unit and the display unit may be configured in various ways. For example, the input unit may include, but is not limited to, a keyboard, a mouse, a trackball, a microphone, a button, a touch panel, or the like.

The resource servers 300 according to the embodiment of the present disclosure may be devices configured to execute services (or execute processes) using resources under the control of the server 100. A plurality of resource servers 300 may be provided as shown in FIG. 1.

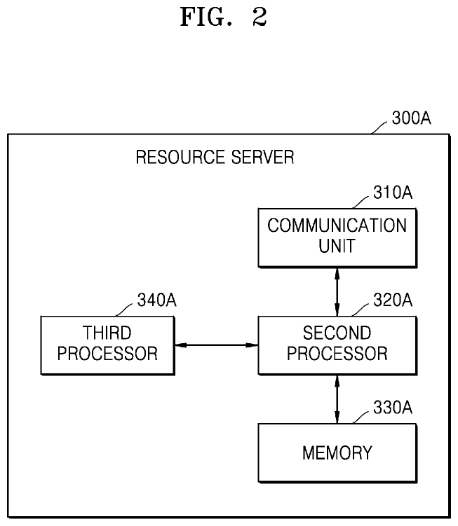

FIG. 2 is a view schematically illustrating a configuration of a resource server 300A according to an embodiment of the present disclosure.

Referring to FIG. 2, the resource server 300A according to the embodiment of the present disclosure may include a communication unit 310A, a second processor 320A, a memory 330A, and a third processor 340A.

The communication unit 310A may be a device including hardware and software necessary for the resource server 300A to transmit/receive signals, such as control signals or data signals, to/from other network devices, such as the server 100, through wired/wireless connections.

The second processor 320A may be a device configured to control the third processor 340A according to a process execution request received from the server 100. For example, the second processor 320A may be a device configured to control the third processor 340A in response to a request such that a process may be performed to provide a predetermined output using a trained artificial neural network.

In this case, the term “processor” may refer to, for example, a data processing device embedded in hardware having a physically structured circuit to perform a function expressed as code or instructions in a program. Examples of the data processing device embedded in hardware may include various processing devices, such as a microprocessor, a central processing unit (CPU), a processor core, a multiprocessor, an application-specific integrated circuit (ASIC), and a field programmable gate array (FPGA). However, the scope of the present disclosure is not limited thereto.

The memory 330A has a function of temporarily or permanently storing data processed by the resource server 300A. The memory 330A may include a magnetic storage medium or a flash storage medium, but the scope of the present disclosure is not limited thereto. For example, the memory 330A may temporarily and/or permanently store data (for example, coefficients) forming a trained artificial neural network. In addition, the memory 330A may also store training data (received from the server 100) for training an artificial neural network. However, this is merely an example, and the spirit of the present disclosure is not limited thereto.

The third processor 340A may be a device configured to perform calculations according to processes under the control of the second processor 320A. In this case, the third processor 340A may have a calculation ability greater than that of the second processor 320A. For example, the third processor 340A may be configured as a graphics processing unit (GPU). However, this is merely an example, and the spirit of the present disclosure is not limited thereto.

In an embodiment of the present disclosure, the third processor 340A may include a plurality of processors, or may include a single processor, as shown in FIG. 2.

In an embodiment of the present disclosure, individual resources of the resource server 300A may be divided and used. As described above, in the present disclosure, the term “resource block” may refer to a virtualized resource including an allocated size of at least one type of resource.

For example, available resources of the resource server 300A may be 3 CPU cores, 8 gigabytes of memory, 5 GPU cores, and 2 gigabytes of GPU memory, and a first resource block may be allocated for a first process. In this case, resources corresponding to the first resource block among the available resources of the resource server 300A may be used for executing the first process. In other words, 0.5 CPU core out of the 3 CPU cores, 2 gigabytes of memory out of the 8 gigabytes of memory, 0.5 GPU core out of the 5 GPU cores, and 0.5 gigabytes of GPU memory out of the 2 gigabytes of GPU memory may be used for executing the first process.

In addition, the remaining resources may be used for the execution of other processes. However, this is merely an example, and the spirit of the present disclosure is not limited thereto.

Although only the configuration of the resource server 300A is described with reference to FIG. 2, the other resource servers may have a structure equivalent to or similar to the structure of the resource server 300A, and thus descriptions of the other resource servers will be omitted.

Furthermore, in an embodiment of the present disclosure, resource servers 300A, 300B, and 300C may have different available resources. In this case, the difference in available resources may be due to different hardware specifications or the number of processes which are currently being executed (or are currently running). However, this is merely an example, and the spirit of the present disclosure is not limited thereto.

The communication network 400 of the embodiment of the present disclosure may refer to a communication network that mediates data transmission and reception between components of the system for managing virtualized resources. Examples of the communication network 400 may include: various wired networks, such as local area networks (LANs), wide area networks (WANs), metropolitan area networks (MANs), and integrated service digital networks (ISDNs), and various wireless networks, such as wireless LANs, CDMA, Bluetooth, and satellite communication networks. However, the scope of the present disclosure is not limited thereto.

The server 100 according to the embodiment of the present disclosure may manage the resources of the resource servers 300 on the basis of resource blocks each including an allocated size of at least one type of resource.

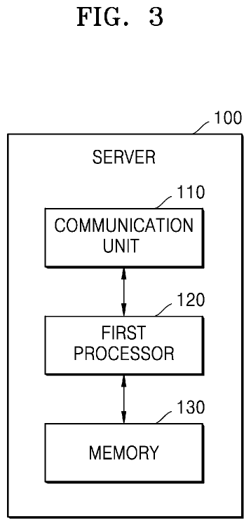

FIG. 3 is a view schematically illustrating a configuration of the server 100 according to an embodiment of the present disclosure.

Referring to FIG. 3, the server 100 according to the embodiment of the present disclosure may include a communication unit 110, a first processor 120, and a memory 130. In addition, although not shown in the drawing, the server 100 according to the present embodiment may further include an input/output unit, a program storage unit, or the like.

The communication unit 110 may be a device including hardware and software necessary for the server 100 to transmit/receive signals, such as control signals or data signals, to/from other network devices, such as the resource servers 100, through wired/wireless connections.

The first processor 120 may be a unit configured to define resource blocks, determine the types and/or quantity of resource blocks required for services, and accordingly, control the resource servers 300.

For example, the first processor 120 may be a data processing device embedded in hardware having a physically structured circuit to perform a function expressed as code or instructions in a program. Examples of the data processing device embedded in hardware may include various processing devices, such as a microprocessor, a central processing unit (CPU), a processor core, a multiprocessor, an application-specific integrated circuit (ASIC), and a field programmable gate array (FPGA). However, the scope of the present disclosure is not limited thereto.

The memory 130 has a function of temporarily or permanently storing data processed by the server 100. The memory 130 may include a magnetic storage medium or a flash storage medium, but the scope of the present disclosure is not limited thereto. For example, the memory 130 may temporarily and/or permanently the sizes of resources included in resource blocks. However, this is merely an example, and the spirit of the present disclosure is not limited thereto.

In the present disclosure, the server 100 may be sometimes described as a resource management device, virtualized resource management device, or a device for recommending the sizes of resources for running services.

FIGS. 4 and 5 are views illustrating example configurations of an artificial neural network.

According to an embodiment of the present disclosure, the artificial neural network may be based on a convolutional neural network (CNN) model, as shown in FIG. 4. In this case, the CNN model may be a layer model, which is used for extracting features of input data through a plurality of sequential computation layers (a convolutional layer and pooling layers). In this case, according to an embodiment of the present disclosure, the server 100 may construct or train the artificial neural network model by processing training data according to a supervised learning method.

According to an embodiment of the present disclosure, the server 100 may generate a convolution layer for extracting feature values of input data, and pooling layers for forming feature maps by combining the extracted feature values.

In addition, according to an embodiment of the present disclosure, the server 100 may combine the generated feature maps to generate a fully connected layer which prepares to determine the probability that the input data corresponds to each of a plurality of items.

Finally, the server 100 may calculate an output layer including an output corresponding to the input data.

In the example shown in FIG. 4, the input data is divided into 5×7 blocks, 5×3 unit blocks are used to generate the convolution layer, and 1×4 or 1×2 unit blocks are used to generate the pooling layers. However, this is merely an example, and the spirit of the present disclosure is not limited thereto.

The division size of the input data, the size of unit blocks used in the convolution layer, the quantity of pooling layers, the size of unit blocks of the pooling layers, and the like may be items included in a parameter set representing training conditions for the artificial neural network. In other words, the parameter set may include parameters (that is, structural parameters) for determining such items described above.

Therefore, the structure of the artificial neural network may be changed by changing and/or adjusting the parameter set, and thus, the results of training may be different even when the same training data is used.

In addition, the artificial neural network may be stored in the memory 330A of the resource server 300A in the form of a coefficient of at least one node of the artificial neural network, a weight for the at least one node, and coefficients of a function defining a relationship between the layers of the artificial neural network. In addition, the structure of the artificial neural network may also be stored in the memory 330A in the form of source code and/or a program.

According to an embodiment of the present disclosure, the artificial neural network may be based on a recurrent neural network (RNN) model, as shown in FIG. 5.

Referring to FIG. 5, the artificial neural network based on an RNN model may include an input layer L1 including at least one input node N1, a hidden layer L2 including a plurality of hidden nodes N2, and an output layer L3 including at least one output node N3.

The hidden layer L2 may include one or more fully connected layers as illustrated. When the hidden layer L2 includes a plurality of layers, the artificial neural network may include a function (not shown) defining a relationship between the layers.

A value included in each node of each layer may be a vector. In addition, each node may include a weight corresponding to the importance of the node.

In addition, the artificial neural network may include a first function F1 defining a relationship between the input layer L1 and the hidden layer L2, and a second function F2 defining a relationship between the hidden layer L2 and the output layer L3.

The first function F1 may define a connection relationship between the input node N1 included in the input layer L1 and the hidden nodes N2 included in the hidden layer L2. Similarly, the second function F2 may define a connection relationship between the hidden nodes N2 included in the hidden layer L2 and the output node N3 included in the output layer L2.

The first function F1, the second function F2, and functions between hidden layers may include an RNN model that outputs a result based on an input of a previous node.

In a process in which the artificial neural network is trained by the resource servers 300, the first function F1 and the second function F2 may be trained based on a plurality of pieces of training data. Furthermore, in the process of training the artificial neural network, functions between a plurality of hidden layers may also be trained in addition to the first function F1 and second function F2.

According to an embodiment of the present disclosure, the artificial neural network may be trained in a supervised learning method based on labeled training data.

According to an embodiment of the present disclosure, the server 100 may train the artificial neural network with a plurality of pieces of training data by repeating a process of updating the functions (F1, F2, functions between hidden layers, etc.) such that an output value obtained by inputting any one piece of input data to the artificial neural network may approach a value included in the training data.

In this case, according to an embodiment of the present disclosure, the server 100 may update the functions (F1, F2, functions between hidden layers, etc.) according to a back propagation algorithm. However, this is merely an example, and the spirit of the present disclosure is not limited thereto.

Furthermore, in the artificial neural network based on an RNN model, a parameter set (particularly, a structural parameter set) may include the quantity of hidden layers and the quantity of input nodes described above. Therefore, the structure of the artificial neural network may be changed by changing and/or adjusting the parameter set, and thus, the results of training may be different even when the same training data is used.

The types and/or structures of the artificial neural network described with reference to FIGS. 4 and 5 are merely example, and the spirit of the present disclosure is not limited thereto. Therefore, artificial neural networks based on various types of models may correspond to the “artificial neural networks” described throughout the specification.

Hereinafter, operations of the first processor 120 of the server 100 will be mainly described.

According to an embodiment of the present disclosure, the first processor 120 may define at least one resource block including an allocated size of at least one type of resource.

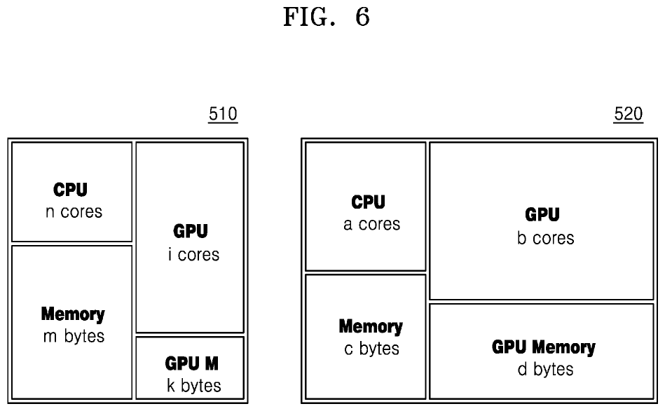

FIG. 6 is a view illustrating example resource blocks.

As described above, in the present disclosure, the term “resource” (or an individual type of resource) may refer to a resource which a computing device may use for a given purpose. For example, for a computing device, such as the resource servers 300, a resource may be a concept encompassing the quantity of available CPU cores, the capacity of available memory, the quantity of available GPU cores, the capacity of available GPU memory, and an available network bandwidth.

Furthermore, in the present disclosure, the term “resource block” may refer to a virtualized resource including an allocated size of at least one type of resource. For example, as shown on the left side of FIG. 6, a resource block 510 may be a combination of individual resources including n CPU cores, m bytes of memory, i GPU cores, and k bytes of GPU memory.

In addition, as shown on the right side, a resource block 520 may be a combination of individual resources including a CPU cores, c bytes of memory, b GPU cores, and d bytes of GPU memory.

According to an embodiment of the present disclosure, the first processor 120 may determine the size of a first type of resource, the size of a second type of resource, the size of a third type of resource, and the size of a fourth type of resource, which are allocated to a first resource block (for example, the resource block 510 shown in FIG. 6). Similarly, the first processor 120 may determine the size of the first type of resource, the size of the second type of resource, the size of the third type of resource, and the size of the fourth type of resource, which are allocated to a second resource block (for example, the resource block 520 shown in FIG. 6). In this case, for example, each type of resource may be any one of CPU cores, memory, GPU cores, and GPU memory.

According to an embodiment of the present disclosure, the first processor 120 may define resource blocks having various configurations (or various types of resource blocks). For example, the first processor 120 may define a resource block having the second type of resource (for example, memory) in a relatively large quantity, or a resource block having the third type of resource (for example, a GPU core) in a relatively large quantity. However, this is merely an example, and the spirit of the present disclosure is not limited thereto.

According to an embodiment of the present disclosure, the first processor 120 may define a resource block based on a user input. For example, the first processor 120 may receive, from the user terminal 200, the size of each type of resource constituting a first type of resource block and the size of each type of resource constituting a second type of resource block, and may define resource blocks based on the received information.

According to an embodiment of the present disclosure, the first processor 120 may define a resource block based on resources (or idle resources) of each of the resource servers 300A, 300B, and 300C.

To this end, the first processor 120 may check the quantity of each type of resource of each of the resource servers 300A, 300B, and 300C in unit size of each type of resource. Examples of the unit size of each type of resource may include 1 core (CPU), 1 MB (memory), 1 core (GPU), and 1 MB (GPU memory), and it may be assumed that the resource server 300A has 100 cores (CPU), 50 MB (memory), 70 cores (GPU), and 80 MB (GPU memory). In this case, the first processor 120 may calculate 100 as the quantity of a CPU resource, 50 as the quantity of a memory resource, 70 as the quantity of a GPU resource, and 80 as the quantity of a GPU memory resource.

In this case, according to an embodiment of the present disclosure, the first processor 120 may calculate the ratio of the quantity of each resource to the quantity of a resource which is minimal in quantity. For example, in the above example, the first processor 120 may calculate the ratio of the quantity of each resource to the quantity (50) of a minimal resource (memory) as 2 (CPU), 1 (memory), 1.4 (GPU), and 1.6 (GPU).

According to an embodiment of the present disclosure, the first processor 120 may determine the ratio of resources included in each resource block with reference to the ratios of resources calculated as described above. For example, the first processor 120 may set resource blocks such that each resource block provided by the processor 340A may include 2 cores (CPU), 1 MB (memory), 1.2 cores (GPU), and 1.6 MB (GPU memory).

Therefore, according to the present disclosure, resource blocks may be generated by considering the characteristics of each of the resource servers 300A, 300B, and 300C.

According to an embodiment of the present disclosure, the first processor 120 may determine the types and quantity of resource blocks required for services. The following description will be given on the assumption that the same type of resource block is defined for each of the resource servers 300A, 300B, and 300C. That is, the following description will be given on the premise that different resource blocks are not defined for the resource servers 300A, 300B, and 300C.

In the present disclosure, as described above, the term “service” may refer to an application to be executed on a computing device, such as the resource servers 300, for a given purpose. For example, a service may refer to an application for a TTS service, which generates voice from text in response to a request from the user terminal 200.

According to an embodiment of the present disclosure, the first processor 120 may obtain a performance value expected for a service. For example, as an expected performance value, the first processor 120 may receive, from the user terminal 200, a maximum response time indicating the maximum seconds within which a user service should provide a response. In this case, the first processor 120 may separately receive an expected performance value under a first traffic condition and an expected performance value under a second traffic condition, or may receive only one performance value regardless of conditions. Descriptions of traffic conditions will be given later.

Furthermore, in addition to the maximum response time, the first processor 120 may also receive, for example, the number (quantity) of operations per unit time as another indicator of expected performance. However, this is merely an example, and the spirit of the present disclosure is not limited thereto.

According to an embodiment of the present disclosure, the first processor 120 may calculate an expected response time for the quantity of each of one or more types of resource blocks under the first traffic condition. In this case, the response time may refer to a time required for a first process of the service to generate a response from a request when the first process is executed using a given quantity of a given type of resource block. In addition, the first traffic condition may refer to a normal traffic condition (or traffic condition corresponding to a normal load).

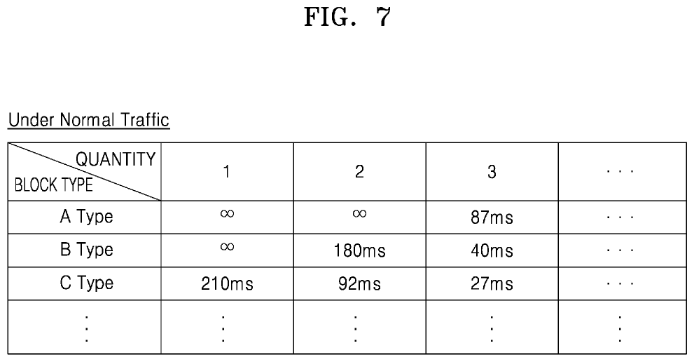

FIG. 7 shows an example of calculating an expected response time for each quantity of one or more types of resource blocks.

As shown in FIG. 7, according to an embodiment of the present disclosure, the first processor 120 may calculate response times for the first process while increasing the quantity of each type of block. For example, the first processor 120 may calculate response times while increasing the quantity of C-type resource blocks.

As described above, according to an embodiment of the present disclosure, the first processor 120 may execute a process for a service and calculate performance values while changing at least one of the type of resource block and the quantity of resource blocks under the first traffic condition.

According to an embodiment of the present disclosure, the first processor 120 may determine combinations of resource block types and resource block quantities that satisfy an expected performance value. In addition, any one of the determined combinations of resource blocks may be used to determine the type of resource block and the quantity of resource blocks required for the first process.

For example, when the expected performance value is 100 ms, the first processor 120 may determine a combination of three or more A-type blocks, a combination of three or more B-type blocks, and a combination of two or more C-type blocks as combinations satisfying the expected performance value. In addition, the first processor 120 may provide the determined combinations to the user terminal 200 such that a user may select any one of the combinations. In this case, the first processor 120 may also provide cost information on each block such that the user may select blocks by considering the cost information.

In an optional embodiment of the present disclosure, under the second traffic condition, the first processor 120 may execute the service while changing the number of processes, which are performed using the above-determined combination of resource block types and quantities, and may calculate performance values from the execution of the service. In addition, the first processor 120 may check the number of processes that satisfies the expected performance value. In this case, the second traffic condition may be a traffic condition (traffic condition corresponding to a heavy load) in which more loads are connected than in the first traffic condition. The first traffic condition and the second traffic condition may be appropriately set according to the type of service.

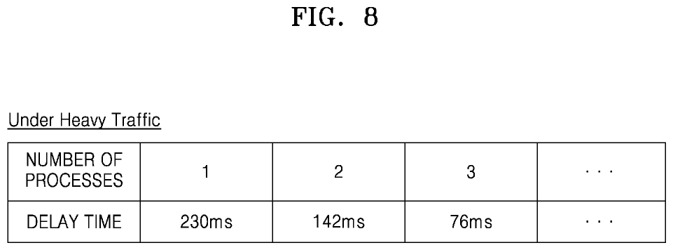

FIG. 8 shows an example of calculating response times expected according to the number of processes.

As shown in FIG. 8, according to an embodiment of the present disclosure, the first processor 120 may calculate response times for the first process while increasing the number of processes under the second traffic condition. In this case, the expression “increasing the number of processes” may refer to increasing the quantity of resource blocks according to the combination determined as described above in a state in which the resource blocks are allocated for respectively performing distinct processes.

In other words, according to an embodiment of the present disclosure, the first processor 120 may calculate a performance value when a plurality of types of resource blocks are used to respectively perform as many processes as the plurality of types of resource blocks. In addition, the first processor 120 may check the number of processes that satisfies an expected performance value.

According to an optional embodiment of the present disclosure, the first processor 120 may determine the total size of resources required to execute a service based on the type of resource block, the quantity of resource blocks, and the number of processes, which are determined as described above.

For example, it may be assumed that a determined type of resource block includes 2 cores (CPU), 1 MB (memory), 1.2 cores (GPU), and 1.6 MB (GPU memory); and an expected performance value is satisfied when one process is performed using three resource blocks of the determined type under a first traffic condition and two such processes are performed under a second traffic condition. In this case, the first processor 120 may determine the total size of resources required to execute a service as 12 cores (CPU), 6 MB (memory), 7.2 cores (GPU), and 9.6 MB (GPU memory).

According to an optional embodiment of the present disclosure, the first processor 120 may determine at least one piece of hardware suitable for executing a service based on the total size of resources calculated as described above. In addition, the first processor 120 may provide the determined piece of hardware to the user terminal 200.

For example, based on the total size of resources, the first processor 120 may provide a cloud service suitable for a user as recommended hardware or may provide hardware having specific specifications (particularly, having a specific GPU) as recommended hardware.

In this manner, according to the present disclosure, hardware suitable for a user service may be recommended and provided based on a performance value expected by a user.

According to an embodiment of the present disclosure, based on the determined resource block type and quantity, the first processor 120 may determine server I from a server pool including a plurality of servers (for example, the resource servers shown in FIG. 1).

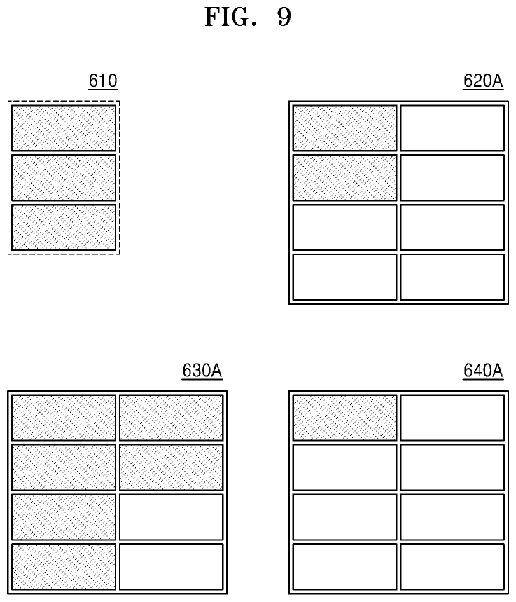

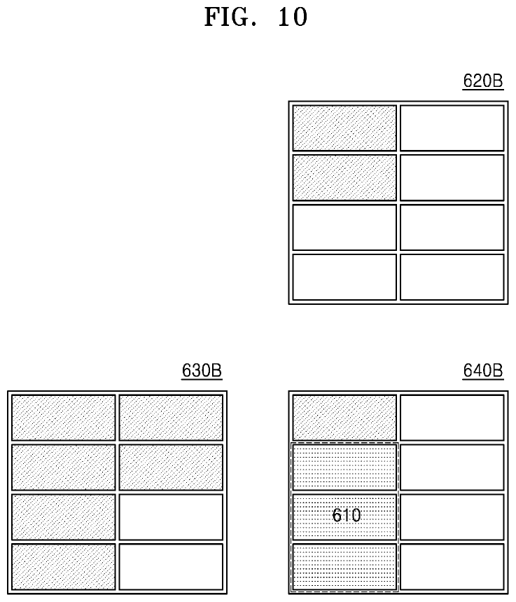

FIGS. 9 to 10 are views illustrating a process in which the first processor 120 determines server I according to an embodiment of the present disclosure. FIG. 9 is a view illustrating requested resources 610 and example resource statuses 620A, 630A, and 640A of resource servers. In FIGS. 9 to 14, unit boxes may refer to individual resource blocks. For example, each of the three boxes included in the requested resources 610 may be an individual resource block, and it may be determined that three resource blocks are required for the execution of a process as described above.

Furthermore, in the resource status of each server, a colored box may refer to a resource in use, and an uncolored box may refer to an idle resource. Even in this case, each box may refer to an individual resource block (or individual resource block unit). For example, in FIG. 9, the status 620A of the first server may mean that as many resources as two resource blocks are used, and as many resources as six resource blocks are idle. All resource statuses described with reference to FIGS. 9 to 14 may be interpreted in this manner.

In an embodiment of the present disclosure, under the above-mentioned assumption, the first processor 120 may check the size of requested resources according to a determined resource block type and quantity. For example, the first processor 120 may determine that three specific resource blocks are required for the execution of a service (especially for an execution satisfying an expected performance value) which requests resources 610 as shown in FIG. 9.

According to an embodiment of the present disclosure, the first processor 120 may search a server pool for one or more servers having idle resources of which the size is equal to or greater than the size of the requested resources 610.

For example, referring to FIG. 9, the first processor 120 may search for a first server and a third server as servers each having idle resources of which the size is equal to or greater than the size of the requested resources 610. For example, the first processor 120 may calculate a requested quantity of each type of resource by considering a determined resource block type and quantity, and may search for a server having idle resources equal to or greater than the calculated quantities of resource types. However, this is merely an example, and the spirit of the present disclosure is not limited thereto.

According to an embodiment of the present disclosure, the first processor 120 may determine, as server I, any one of one or more servers which are searched for according to given conditions.

FIG. 10 is a view illustrating resource statuses 620B, 630B, and 640B in an example situation in which a third server is determined as server I.

The first processor 120 may determine, as server I, a third server having the most idle resources among one or more searched servers as shown in FIG. 10, or a server that is not performing a process (existing process) related to a corresponding service among one or more searched servers. However, this is merely an example, and the spirit of the present disclosure is not limited thereto.

In addition, when the third server is determined as server I, as many resources as requested resources 610 may be used for performing a first process for a service among resources of the third server, as shown in FIG. 10.

According to an embodiment of the present disclosure, the first processor 120 may execute the first process for the service on server I determined as described above.

In the present disclosure, as described above, “executing” a process may refer to creating a container corresponding to a resource block type and size which are determined for the process and executing the process (or a program corresponding to the process) in the created container.

For example, when the third server is determined as server I, the first processor 120 may create, in the third server, a container to which a resource size corresponding to a determined resource block type and quantity is allocated, and may execute the first process for the service in the created container. In this case, the term “container” may refer to a set of processes that may abstract (or isolate) applications (or individual processes) from an actual operating environment (or the rest of the system).

As described above, according to the present disclosure, resources may be isolated, allocated, and managed according to the scale of a service. In particular, resource sizes and resources may be allocated and managed suitably for an artificial intelligence model.

According to an embodiment of the present disclosure, the first processor 120 may add and execute a new process when the performance of the service deteriorates during the execution of the service.

For example, when traffic exceeds the second traffic condition, the performance of the service may be lower than the expected performance value. In this case, the service may not be smoothly provided with the same quantity of resources.

According to an embodiment of the present disclosure, when the response time of the process executed on server I satisfies a predetermined condition, the first processor 120 may determine, with reference to the resource block type and quantity required for the service, server II from the server pool to additionally execute the service on server II. In addition, the first processor 120 may execute a second process for the service on server II.

Furthermore, in the present disclosure, server II may be a concept including server I, that is, including a server in which a process is currently executed. Therefore, the subject that executes the first process is not excluded from the subject that executes the second process.

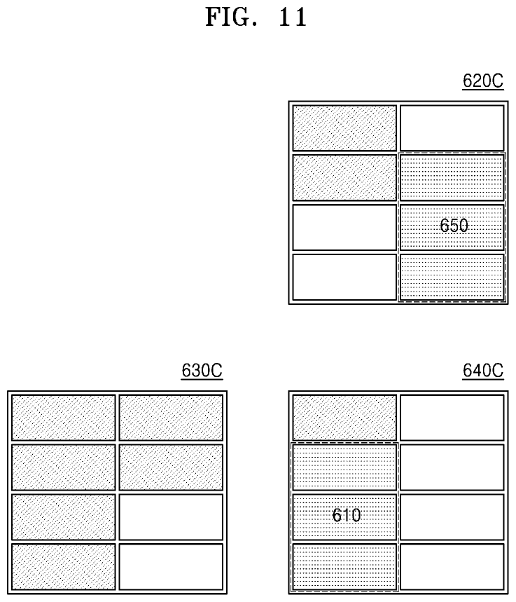

FIG. 11 is a view illustrating resource statuses 620C, 630C, and 640C in an example situation in which a first server is determined as server II in the situation shown in FIG. 10. Referring to FIG. 11, it may be seen that the first server is allocated as many additional resources 650 as requested resources 610 which are allocated to the third server for the first process.

According to an embodiment of the present disclosure, based on a first delay time, which is a time required for generating a response to a request of the first process, and a second delay time, which is a time required for generating a response to a request of the second process, the first processor 120 may determine one of the first process and the second process as a process for processing a new request. In this case, the first process may be a process executed on the third server in FIG. 11, and the second process may be a process executed on the first server in FIG. 11.

For example, when the service is a TTS service for generating voice from text, both the first process and the second process may be for generating voice from text using a trained artificial neural network. In this case, when the first process is for processing 10 requests and the second process is for processing 5 requests, the delay time of the second process may be less than the delay time of the first process. In this case, based on results of the comparison of the delay times, the first processor 120 may determine that new requests are processed by the second process.

Therefore, according to the present disclosure, service performance may be maintained uniform by balancing loads between processes.

In an optional embodiment of the present disclosure, when the response time of the second process executed on server II satisfies a predetermined condition, and a predetermined threshold time has elapsed after the second process is created, the first processor 120 may determine a server for additional execution of the service from the server pool and may execute a new process on the server.

In this case, the first processor 120 may refer to the maximum number of processes for the same service and may add new processes within the maximum number of processes.

Therefore, according to the present disclosure, resources for a service may be dynamically allocated according to traffic conditions.

Furthermore, in an optional embodiment of the present disclosure, the first processor 120 may terminate at least one process when the total response time of the service is less than a predetermined minimum response time. For example, when the first process and the second process are being performed for the service, the first processor 120 may not allocate new requests to the second process and may stop the second process after all requests being processed by the second process are terminated.

According to an embodiment of the present disclosure, when a problem occurs while executing process, the first processor 120 may terminate the process and may simultaneously execute a new process.

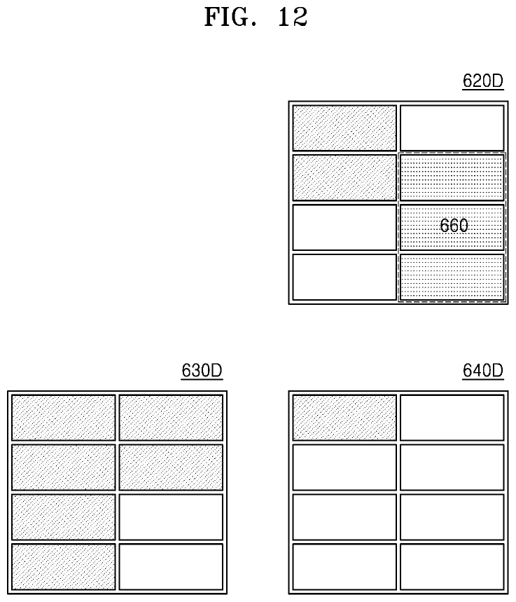

FIG. 12 is a view illustrating resource statuses 620D, 630D, and 640D in an example situation in which the first server is determined as server III in the situation shown in FIG. 10.

According to an embodiment of the present disclosure, when it is determined that the first process executed on server I is in a predetermined state, the first processor 120 may select server III for additionally executing the service from the server pool with reference to the resource block type and quantity required for the service. In this case, server III may be a concept including server I, that is, including a server in which an existing process is executed. Therefore, the subject that executes the first process is not excluded from the subject that executes a third process. Furthermore, the “predetermined state” may include various types of states in which the service is not normally performed. For example, the predetermined state may be a state in which there is no response to a request or a state in which a delay time is equal to or greater than a predetermined threshold time.

According to an embodiment of the present disclosure, the first processor 120 may execute the third process for the service on server III. In addition, the first processor 120 may request server I to stop the first process, which is being executed on server I. Referring to FIG. 12, it may be seen that additional resources 660 are allocated to the first server, and requested resources 610 allocated to the third server are returned to an idle state.

Therefore, according to the present disclosure, even when a problem occurs in a service, the service may be continuously provided without user intervention. In particular, errors may frequently occur in a service using an artificial neural network because of a large amount of computation and a complex system structure. However, according to the present disclosure, a service may be provided substantially without interruption by executing new processes while newly allocating resources according to error situations.

According to an embodiment of the present disclosure, when it is required to update a process, which is currently being executed, the first processor 120 may temporarily execute both the old and updated processes in parallel with each other.

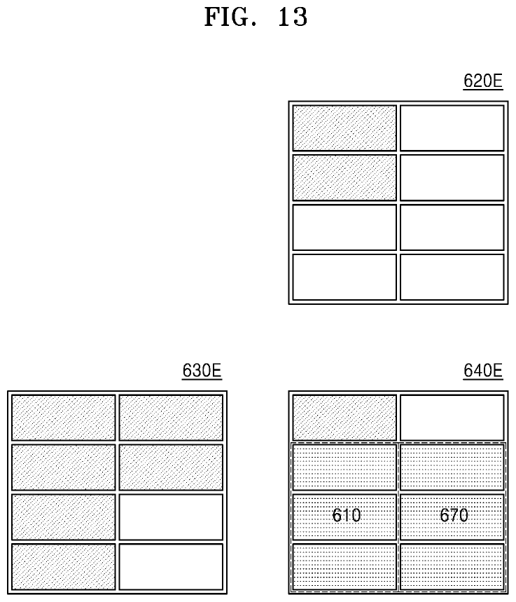

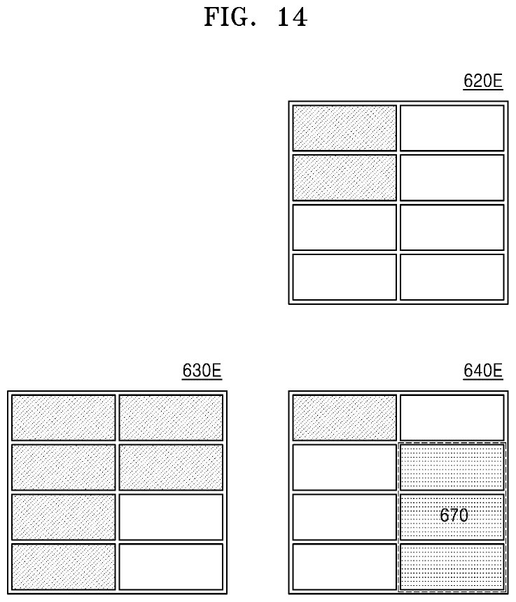

FIGS. 13 and 14 are views illustrating resource statuses 620E, 630E, and 640E over time when a process is updated in the situation shown in FIG. 10.

In an embodiment of the present disclosure, when the service (or process) is updated, the first processor 120 may select server IV for additionally executing the service from the server pool by referring to a resource block type and quantity required for the service. For example, the first processor 120 may determine, as server IV, server I, which currently executes the first process. Therefore, the first processor 120 may allocate additional resources 670 to server I for the execution of a fourth process, which is a new process as shown in FIG. 13.

According to an embodiment of the present disclosure, the first processor 120 may execute the fourth process for the updated service on server IV. In addition, the first processor 120 may stop the first process when requests to the first process running on server I are reduced and/or terminated. Referring to FIG. 14, it may be seen that as many resources as requested resources 610 for the first process are returned to an idle state.

Therefore, according to the present disclosure, even when a service is updated, the service may be continuously provided without interruption. In particular, a service using an artificial neural network may be frequently updated because of a large amount of computation and a complex system structure. However, according to the present disclosure, old and new processes are temporarily performed together by additionally allocating resources according to updates, and thus, a service may be provided substantially without interruption.

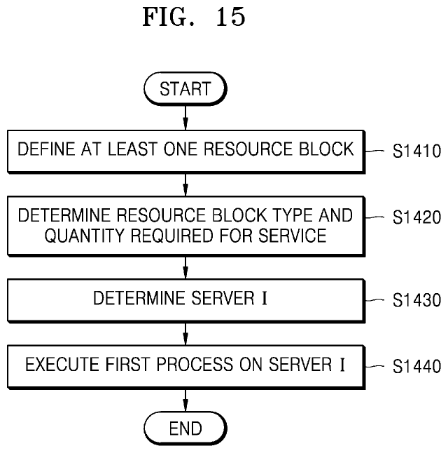

FIG. 15 is a flowchart illustrating a resource management method according to an embodiment of the present disclosure. Hereinafter, descriptions that are the same as those given with reference to FIGS. 1 to 14 will be omitted, but the following description will be given by also referring to FIGS. 1 to 14.

According to an embodiment of the present disclosure, the first processor 120 may define at least one resource block including an allocated size of at least one type of resource (S1410).

FIG. 6 is a view illustrating example resource blocks.

As described above, in the present disclosure, the term “resource” (or an individual type of resource) may refer to a resource which a computing device may use for a given purpose. For example, for a computing device, such as the resource servers 300, a resource may be a concept encompassing the quantity of available CPU cores, the capacity of available memory, the quantity of available GPU cores, the capacity of available GPU memory, and an available network bandwidth.

Furthermore, in the present disclosure, the term “resource block” may refer to a virtualized resource including an allocated size of at least one type of resource. For example, as shown on the left side of FIG. 6, the resource block 510 may be a combination of individual resources including n CPU cores, m bytes of memory, i GPU cores, and k bytes of GPU memory.

In addition, as shown on the right side, the resource block 520 may be a combination of individual resources including a CPU cores, c bytes of memory, b GPU cores, and d bytes of GPU memory.

According to an embodiment of the present disclosure, the first processor 120 may determine the size of a first type of resource, the size of a second type of resource, the size of a third type of resource, and the size of a fourth type of resource, which are allocated to a first resource block (for example, the resource block 510 shown in FIG. 6). Similarly, the first processor 120 may determine the size of the first type of resource, the size of the second type of resource, the size of the third type of resource, and the size of the fourth type of resource, which are allocated to a second resource block (for example, the resource block 520 shown in FIG. 6). In this case, for example, each type of resource may be any one of CPU cores, memory, GPU cores, and GPU memory.

According to an embodiment of the present disclosure, the first processor 120 may define resource blocks having various configurations (or various types of resource blocks). For example, the first processor 120 may define a resource block having the second type of resource (for example, memory) in a relatively large quantity, or a resource block having the third type of resource (for example, GPU core) in a relatively large quantity. However, this is merely an example, and the spirit of the present disclosure is not limited thereto.

According to an embodiment of the present disclosure, the first processor 120 may define a resource block based on a user input. For example, the first processor 120 may receive, from the user terminal 200, the size of each type of resource constituting a first type of resource block and the size of each type of resource constituting a second type of resource block, and may define resource blocks based on the received information.

According to an embodiment of the present disclosure, the first processor 120 may define a resource block based on resources (or idle resources) of each of the resource servers 300A, 300B, and 300C.

To this end, the first processor 120 may check the quantity of each type of resource of each of the resource servers 300A, 300B, and 300C in unit size of each type of resource. Examples of the unit size of each type of resource may include 1 core (CPU), 1 MB (memory), 1 core (GPU), and 1 MB (GPU memory), and it may be assumed that the resource server 300A has 100 cores (CPU), 50 MB (memory), 70 cores (GPU), and 80 MB (GPU memory). In this case, the first processor 120 may calculate 100 as the quantity of a CPU resource, 50 as the quantity of a memory resource, 70 as the quantity of a GPU resource, and 80 as the quantity of a GPU memory resource.

In this case, according to an embodiment of the present disclosure, the first processor 120 may calculate the ratio of the quantity of each resource to the quantity of a resource which is minimal in quantity. For example, in the above example, the first processor 120 may calculate the ratio of the quantity of each resource to the quantity (50) of a minimal resource (memory) as 2 (CPU), 1 (memory), 1.4 (GPU), and 1.6 (GPU).

According to an embodiment of the present disclosure, the first processor 120 may determine the ratio of resources included in each resource block with reference to the ratios of resources calculated as described above. For example, the first processor 120 may set resource blocks such that each resource block provided by the processor 340A may include 2 cores (CPU), 1 MB (memory), 1.2 cores (GPU), and 1.6 MB (GPU memory).

Therefore, according to the present disclosure, resource blocks may be generated by considering the characteristics of each of the resource servers 300A, 300B, and 300C.

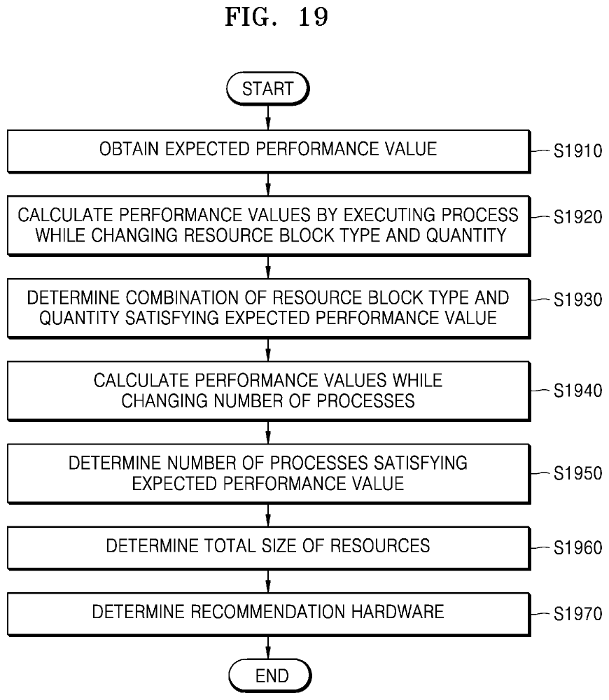

According to an embodiment of the present disclosure, the first processor 120 may determine the types and quantity of resource blocks required for services (S1420). Operation S1420 will be described later with reference to FIG. 19.

According to an embodiment of the present disclosure, based on the determined resource block type and quantity, the first processor 120 may determine server I from a server pool including a plurality of servers (for example, the resource servers shown in FIG. 1) (S1430).

FIGS. 9 to 10 are views illustrating a process in which the first processor 120 determines server I according to an embodiment of the present disclosure. FIG. 9 is a view illustrating requested resources 610 and example resource statuses 620A, 630A, and 640A of resource servers. In FIGS. 9 to 14, unit boxes may refer to individual resource blocks. For example, each of the three boxes included in the requested resources 610 may be an individual resource block, and it may be determined that three resource blocks are required for the execution of a process as described above.

Furthermore, in the resource status of each server, a colored box may refer to a resource in use, and an uncolored box may refer to an idle resource. Even in this case, each box may refer to an individual resource block (or individual resource block unit). For example, in FIG. 9, the status 620A of the first server may mean that as many resources as two resource blocks are used, and as many resources as six resource blocks are idle. All resource statuses described with reference to FIGS. 9 to 14 may be interpreted in this manner.

In an embodiment of the present disclosure, under the above-mentioned assumption, the first processor 120 may check the size of requested resources according to a determined resource block type and quantity. For example, the first processor 120 may determine that three specific resource blocks are required for the execution of a service (especially for an execution satisfying an expected performance value) which requests resources 610 as shown in FIG. 9.

According to an embodiment of the present disclosure, the first processor 120 may search a server pool for one or more servers having idle resources of which the size is equal to or greater than the size of the requested resources 610.

For example, referring to FIG. 9, the first processor 120 may search for a first server and a third server as servers each having idle resources of which the size is equal to or greater than the size of the requested resources 610. For example, the first processor 120 may calculate a requested quantity of each type of resource by considering a determined resource block type and quantity, and may search for a server having idle resources equal to or greater than the calculated quantities of resource types. However, this is merely an example, and the spirit of the present disclosure is not limited thereto.

According to an embodiment of the present disclosure, the first processor 120 may determine any one of one or more servers which are searched for according to given conditions.

FIG. 10 is a view illustrating resource statuses 620B, 630B, and 640B in an example situation in which a third server is determined as server I.

The first processor 120 may determine, as server I, a third server having the most idle resources among one or more searched servers as shown in FIG. 10, or a server that is not performing a process (existing process) related to a corresponding service among one or more searched servers. However, this is merely an example, and the spirit of the present disclosure is not limited thereto.

In addition, when the third server is determined as server I, as many resources as requested resources 610 may be used for performing a first process for a service among resources of the third server as shown in FIG. 10.

According to an embodiment of the present disclosure, the first processor 120 may execute the first process for the service on server I determined as described above (S1440).

In the present disclosure, as described above, “executing” a process may refer to creating a container corresponding to a resource block type and size which are determined for the process and executing the process (or a program corresponding to the process) in the created container.

For example, when the third server is determined as server I, the first processor 120 may create, in the third server, a container to which a resource size corresponding to a determined resource block type and quantity is allocated, and may execute the first process for the service in the created container. In this case, the term “container” may refer to a set of processes that may abstract (or isolate) applications (or individual processes) from an actual operating environment (or the rest of the system).

As described above, according to the present disclosure, resources may be isolated, allocated, and managed according to the scale of a service. In particular, resource sizes and resources may be allocated and managed suitably for an artificial intelligence model.

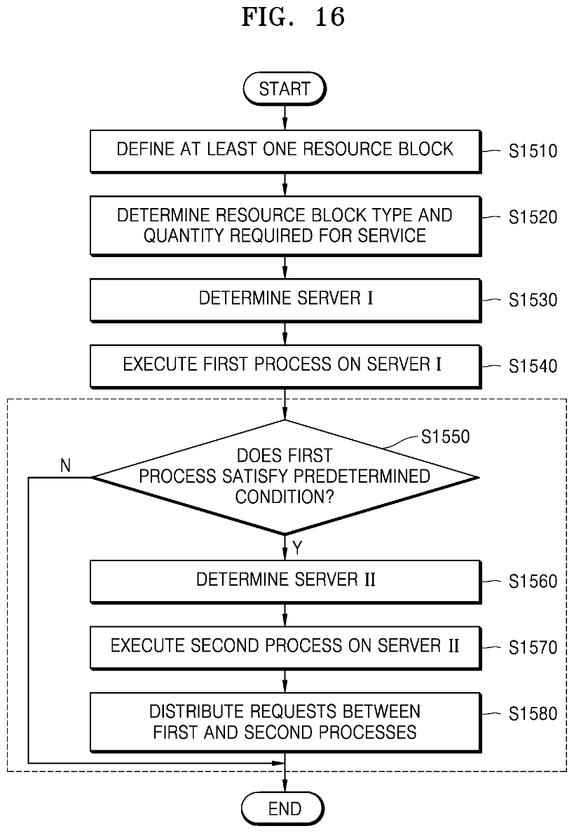

FIG. 16 is a flowchart illustrating a resource management method according to an embodiment of the present disclosure. Operations S1510 to S1540 in FIG. 16 are substantially the same as operations S1410 to S1440 in FIG. 15, and thus descriptions thereof will be omitted.

According to an embodiment of the present disclosure, the first processor 120 may add and execute a new process when the performance of the service deteriorates during the execution of the service. For example, when traffic exceeds the second traffic condition, the performance of the service may be lower than the expected performance value. In this case, the service may not be smoothly provided with the same quantity of resources.

According to an embodiment of the present disclosure, the first processor 120 determines whether the response time of the process executed on server I satisfies a predetermined condition (S1550), and when the first processor 120 determines that the response time of the process executed on server I satisfies the predetermined condition, the first processor 120 may determine, with reference to the resource block type and quantity required for the service, server II from the server pool to additionally execute the service on server II (S1560). In addition, the first processor 120 may execute a second process for the service on server II (S1570).

Furthermore, in the present disclosure, server II may be a concept including server I, that is, including a server in which a process is currently executed. Therefore, the subject that executes the first process is not excluded from the subject that executes the second process.

FIG. 11 is a view illustrating resource statuses 620C, 630C, and 640C in an example situation in which a first server is determined as server II in the situation shown in FIG. 10. Referring to FIG. 11, it may be seen that the first server is allocated as many additional resources 650 as requested resources 610 which are allocated to the third server for the first process.

According to an embodiment of the present disclosure, based on a first delay time, which is a time required for generating a response to a request of the first process, and a second delay time, which is a time required for generating a response to a request of the second process, the first processor 120 may determine one of the first process and the second process as a process for processing a new request. That is, the first processor 120 may distribute requests between the first process and the second process (S1580). In this case, the first process may be a process executed on the third server in FIG. 11, and the second process may be a process executed on the first server in FIG. 11.

For example, when the service is a TTS service for generating voice from text, both the first process and the second process may be for generating voice from text using a trained artificial neural network. In this case, when the first process is for processing 10 requests and the second process is for processing 5 requests, the delay time of the second process may be less than the delay time of the first process. In this case, based on results of the comparison of the delay times, the first processor 120 may determine that new requests are processed by the second process.

Therefore, according to the present disclosure, service performance may be maintained uniform by balancing loads between processes.

In an optional embodiment of the present disclosure, when the response time of the second process executed on server II satisfies a predetermined condition, and a predetermined threshold time has elapsed after the second process is created, the first processor 120 may determine a server for additional execution of the service from the server pool and may execute a new process on the server.

In this case, the first processor 120 may refer to the maximum number of processes for the same service and may add new processes within the maximum number of processes.

Therefore, according to the present disclosure, resources for a service may be dynamically allocated according to traffic conditions.

Furthermore, in an optional embodiment of the present disclosure, the first processor 120 may terminate at least one process when the total response time of the service is less than a predetermined minimum response time. For example, when the first process and the second process are being performed for the service, the first processor 120 may not allocate new requests to the second process and may stop the second process after requests being processed by the second process are reduced and/or terminated.

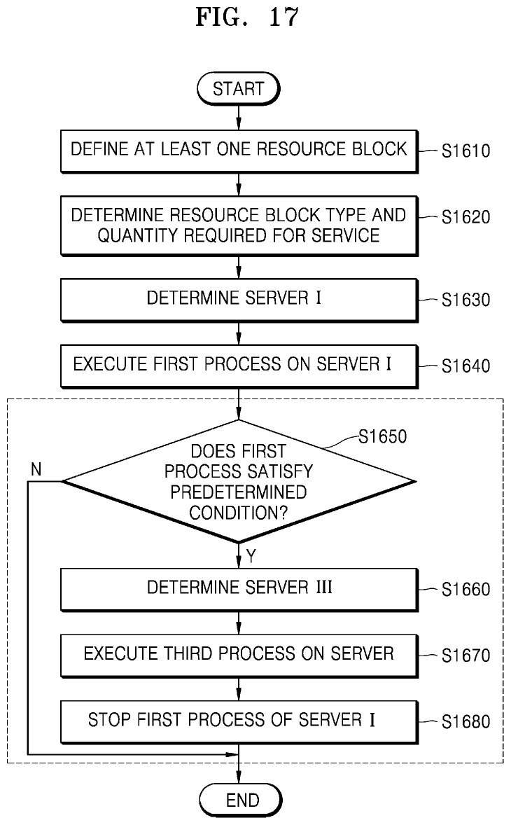

FIG. 17 is a flowchart illustrating a resource management method according to an embodiment of the present disclosure. Operations S1610 to S1640 in FIG. 17 are substantially the same as operations S1410 to S1440 in FIG. 15, and thus descriptions thereof will be omitted.

According to an embodiment of the present disclosure, when a problem occurs while executing process, the first processor 120 may terminate the process and may simultaneously execute a new process.

FIG. 12 is a view illustrating resource statuses 620D, 630D, and 640D in an example situation in which the first server is determined as server III in the situation shown in FIG. 10.

According to an embodiment of the present disclosure, the first processor 120 may determine whether the first process executed on server I is in a predetermined state (S1650), and when the first processor 120 determines that the first process executed on server I is in the predetermined state, the first processor 120 may select server III for additionally executing the service from the server pool with reference to the resource block type and quantity required for the service (S1660). In this case, server III may be a concept including server I, that is, including a server in which an existing process is executed. Therefore, the subject that executes the first process is not excluded from the subject that executes a third process. Furthermore, the “predetermined state” may include various types of states in which the service is not normally performed. For example, the predetermined state may be a state in which there is no response to a request or a state in which a delay time is equal to or greater than a predetermined threshold time.

According to an embodiment of the present disclosure, the first processor 120 may execute the third process for the service on server III (S1670). In addition, the first processor 120 may request server I to stop the first process, which is being executed on server I (S1680). Referring to FIG. 12, it may be seen that additional resources 660 are allocated to the first server, and requested resources 610 allocated to the third server are returned to an idle state.

Therefore, according to the present disclosure, even when a problem occurs in a service, the service may be continuously provided without user intervention. In particular, errors may frequently occur in a service using an artificial neural network because of a large amount of computation and a complex system structure. However, according to the present disclosure, a service may be provided substantially without interruption by executing new processes while newly allocating resources according to error situations.

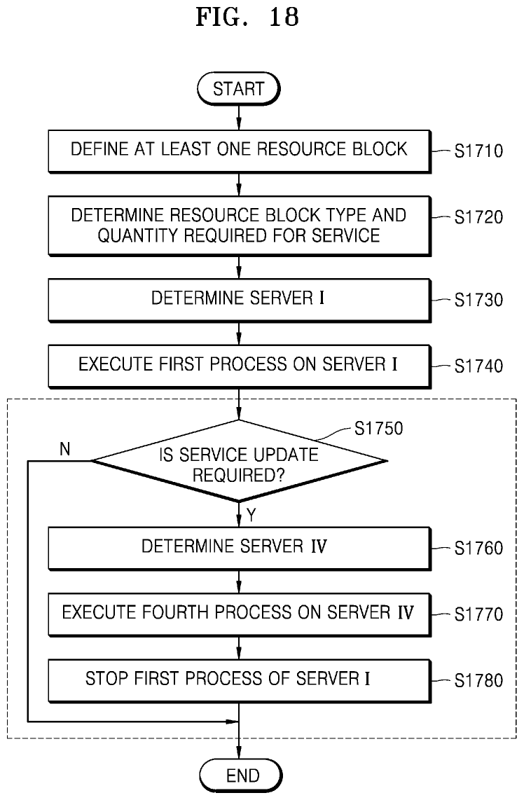

FIG. 18 is a flowchart illustrating a resource management method according to an embodiment of the present disclosure. Operations S1710 to S1740 in FIG. 18 are substantially the same as operations S1410 to S1440 in FIG. 15, and thus descriptions thereof will be omitted.

According to an embodiment of the present disclosure, when it is required to update a process, which is currently being executed, the first processor 120 may temporarily execute both the old and updated processes in parallel with each other.

FIGS. 13 and 14 are views illustrating resource statuses 620E, 630E, and 640E over time when a process is updated in the situation shown in FIG. 10.

In an embodiment of the present disclosure, the first processor 120 determines whether it is required to update the service (or process) (S1750), and when the first processor 120 determines that it is required to update the service, the first processor 120 may select server IV for additionally executing the service from the server pool by referring to a resource block type and quantity required for the service (S1760).

For example, the first processor 120 may determine, as server IV, server I, which currently executes the first process. Therefore, the first processor 120 may allocate additional resources 670 to server I for the execution of a fourth process, which is a new process as shown in FIG. 13.

According to an embodiment of the present disclosure, the first processor 120 may execute the fourth process for the updated service on server IV (S1770). In addition, the first processor 120 may stop the first process when requests to the first process running on server I are reduced and/or terminated (S1780). Referring to FIG. 14, it may be seen that as many resources as requested resources 610 for the first process are returned to an idle state.

Therefore, according to the present disclosure, even when a service is updated, the service may be continuously provided without interruption. In particular, a service using an artificial neural network may be frequently updated because of a large amount of computation and a complex system structure. However, according to the present disclosure, old and new processes are temporarily performed together by additionally allocating resources according to updates, and thus, a service may be provided substantially without interruption.

FIG. 19 is a flowchart illustrating a method of recommending a resource size, according to an embodiment of the present disclosure.

The following description will be given on the assumption that the same type of resource block is defined for each of the resource servers 300A, 300B, and 300C. That is, the following description will be given on the premise that different resource blocks are not defined for the resource servers 300A, 300B, and 300C.

In the present disclosure, as described above, the term “service” may refer to an application to be executed on a computing device, such as the resource servers 300, for a given purpose. For example, a service may refer to an application for a TTS service, which generates voice from text in response to a request from the user terminal 200.

According to an embodiment of the present disclosure, the first processor 120 may obtain a performance value expected for a service (S1910). For example, as an expected performance value, the first processor 120 may receive, from the user terminal 200, a maximum response time indicating the maximum seconds within which a user service should provide a response. In this case, the first processor 120 may separately receive an expected performance value under a first traffic condition and an expected performance value under a second traffic condition, or may receive only one performance value regardless of conditions. Descriptions of traffic conditions will be given later.

Furthermore, in addition to the maximum response time, the first processor 120 may also receive, for example, the number (quantity) of operations per unit time as another indicator of expected performance. However, this is merely an example, and the spirit of the present disclosure is not limited thereto.

According to an embodiment of the present disclosure, the first processor 120 may calculate an expected response time for the quantity of each of one or more types of resource blocks under the first traffic condition. In this case, the response time may refer to a time required for a first process of the service to generate a response from a request when the first process is executed using a given quantity of a given type of resource block. In addition, the first traffic condition may refer to a normal traffic condition (or traffic condition corresponding to a normal load).

FIG. 7 shows an example of calculating an expected response time for each quantity of one or more types of resource blocks.

As shown in FIG. 7, according to an embodiment of the present disclosure, the first processor 120 may calculate response times for the first process while increasing the quantity of each type of block (S1920). For example, the first processor 120 may calculate response times while increasing the quantity of C-type resource blocks.

As described above, according to an embodiment of the present disclosure, the first processor 120 may execute a process for a service and calculate performance values while changing at least one of the type of resource block and the quantity of resource blocks under the first traffic condition.

According to an embodiment of the present disclosure, the first processor 120 may determine combinations of resource block types and resource block quantities that satisfy an expected performance value (S1930). In addition, any one of the determined combinations of resource blocks may be used to determine the type of resource block and the quantity of resource blocks required for the first process.

For example, when the expected performance value is 100 ms, the first processor 120 may determine a combination of three or more A-type blocks, a combination of three or more B-type blocks, and a combination of two or more C-type blocks as combinations satisfying the expected performance value. In addition, the first processor 120 may provide the determined combinations to the user terminal 200 such that a user may select any one of the combinations. In this case, the first processor 120 may also provide cost information on each block such that the user may select blocks by considering the cost information.

In an optional embodiment of the present disclosure, under the second traffic condition, the first processor 120 may execute the service while changing the number of processes, which are performed using the above-determined combination of resource block types and quantities, and may calculate performance values from the execution of the service (S1940). In addition, the first processor 120 may check the number of processes that satisfies the expected performance value (S1950). In this case, the second traffic condition may be a traffic condition (traffic condition corresponding to a heavy load) in which more loads are connected than in the first traffic condition. The first traffic condition and the second traffic condition may be appropriately set according to the type of service.

FIG. 8 shows an example of calculating response times expected according to the number of processes.

As shown in FIG. 8, according to an embodiment of the present disclosure, the first processor 120 may calculate response times for the first process while increasing the number of processes under the second traffic condition. In this case, the expression “increasing the number of processes” may refer to increasing the quantity of resource blocks according to the combination determined as described above in a state in which the resource blocks are allocated for respectively performing distinct processes.

In other words, according to an embodiment of the present disclosure, the first processor 120 may calculate a performance value when a plurality of types of resource blocks are used to respectively perform as many processes as the plurality of types of resource blocks. In addition, the first processor 120 may check the number of processes that satisfies an expected performance value.

According to an optional embodiment of the present disclosure, the first processor 120 may determine the total size of resources required to execute a service based on the type of resource block, the quantity of resource blocks, and the number of processes, which are determined as described above (S1960).

For example, it may be assumed that a determined type of resource block includes 2 cores (CPU), 1 MB (memory), 1.2 cores (GPU), and 1.6 MB (GPU memory); and an expected performance value is satisfied when one process is performed using three resource blocks of the determined type under a first traffic condition and two such processes are performed under a second traffic condition. In this case, the first processor 120 may determine the total size of resources required to execute a service as 12 cores (CPU), 6 MB (memory), 7.2 cores (GPU), and 9.6 MB (GPU memory).

According to an optional embodiment of the present disclosure, the first processor 120 may determine at least one piece of hardware suitable for executing a service based on the total size of resources calculated as described above (S1970). In addition, the first processor 120 may provide the determined piece of hardware to the user terminal 200.

For example, based on the total size of resources, the first processor 120 may provide a cloud service suitable for a user as recommended hardware or may provide hardware having specific specifications (particularly, having a specific GPU) as recommended hardware.

In this manner, according to the present disclosure, hardware suitable for a user service may be recommended and provided based on a performance value expected by a user.

The above-described embodiments may be implemented in the form of computer programs executable on a computer using various components, and such computer programs may be stored in non-transitory computer readable media. In this case, the medium may be to store a program executable by a computer. Examples of the non-transitory computer readable media may include: magnetic media such as hard disks, floppy disks, and magnetic tapes; optical recording media such as CD-ROMs and DVDs; magneto-optical media such as floptical disks; and ROMs, RAMs, and flash memories, which are configured to store program instructions.

In addition, the computer programs may be those designed and configured according to the embodiments or well known in the computer software industry. Examples of the computer programs may include machine code made by compilers and high-level language code executable on computers using interpreters.

In addition, specific executions described herein are merely examples and do not limit the scope of the present disclosure in any way. For simplicity of description, descriptions of known electric components, control systems, software, and other functional aspects thereof may not be given. Furthermore, line connections or connection members between elements depicted in the drawings represent functional connections and/or physical or circuit connections by way of example, and in actual applications, they may be replaced or embodied as various additional functional connections, physical connections, or circuit connections. Elements described without using terms such as “essential” and “important” may not be necessary for constituting the present disclosure.

That is, the scope of the present disclosure is not limited to the embodiments but should be defined by the appended claims, and all equivalents or equivalent modifications thereof.

1. A resource management device for managing virtualized resources, the resource management device being configured to:
define at least one resource block comprising an allocated size of at least one type of resource;
determine a resource block type and a resource block quantity required for a service;
determine, based on the resource block type and the resource block quantity, a first server for executing the service from a server pool comprising a plurality of servers; and
execute a first process on the first server according to the service.

2. The resource management device of claim 1, wherein when defining the at least one resource block, the resource management device is configured to:
determine a size of a first type of resource, a size of a second type of resource, a size of a third type of resource, and a size of a fourth type of resource, which are allocated to a first resource block; and
determine a size of the first type of resource, a size of the second type of resource, a size of the third type of resource, and a size of the fourth type of resource, which are allocated to a second resource block.

3. The resource management device of claim 1, wherein when determining the resource block quantity, the resource management device is configured to:
calculate an expected response time for a quantity of each of at least one type of resource block, the response time referring to a time required for the first process to generate a response to a request when the first process is executed using a predetermined quantity of a predetermined type of resource block; and
determine, with reference to the response time, a resource block type and a resource block quantity, which are required for the first process.

4. The resource management device of claim 1, wherein when a response time of the first process executed on the first server satisfies a predetermined condition, the resource management device is configured to:
determine, with reference to the resource block type and the resource block quantity required for the service, a second server from the server pool to additionally execute the service on the second server; and
execute a second process on the second server according to the service.

5. The resource management device of claim 4, wherein the resource management device is configured to determine, based on a first delay time required for the first process to generate a response to a request and a second delay time required for the second process to generate a response to the request, one of the first process and the second process as a process for processing a new request.
